(19) United States
(12) Patent Application Publication
(10) Pub. No.: US 2002/0084300 A1
(43) Pub. Date: Jul. 4, 2002

(54) Apparatus and method for separating circuit boards

(76) Inventors: Charles Elkins, White Lake, MI (US); Dennis Perry, Trenton, MI (US)

Correspondence Address: Thomas E. Donohue, Artz & Artz, PC, Suite 250, 28333 Telegraph Road, Southfield, MI, 48034, US

(21) Appl. No.: 09/751,975

(22) Filed: Dec. 29, 2000

(51) Int. Cl. B26F 3/00

(52) U.S. Cl. 225/1; 225/96.5; 225/103

(57) ABSTRACT

An apparatus for separating individual circuit boards from a multiple board array with pre-scored planes 10 is provided. The apparatus includes a splitting element 36, positioned along one of the pre-scored planes 28, and a torque inducing element 38 mechanically forcing the multiple board array 20 onto the splitting element 36 thereby breaking the board array 20 along the pre-scored plane 28.

### TECHNICAL FIELD

The present invention relates generally to an apparatus and method for separating circuit boards and, more particularly, to an apparatus and method for separating circuit boards from a multiple pre-scored board array.

### BACKGROUND OF THE INVENTION

Individual circuit boards are often formed initially on multiple board arrays. These multiple board arrays provide advantages in the manufacturing and assembly of components utilizing these circuit boards.

Passing larger boards through machinery and processes to attach circuitry and electronic components to the circuit boards is well known to improve the efficiency and reduce the cost of component construction. Although manufacturing and assembly of individual components on multiple board arrays has known advantages and benefits, the separation of such multiple board arrays into individual circuit boards after assembly can pose a variety of difficulties.

Multi-board arrays often come in a variety of configurations. Known configurations include punch boards, perforated boards and V-scored boards to name just a few. Commonly, such multi-board arrays are separated into individual boards by manually breaking the boards apart, through the use of a saw or router to cut the boards apart or through the use of devices to punch out tabs between sections of the board. These methods have disadvantages. Manually breaking the boards apart by hand can be both time-consuming and labor intensive. Furthermore, it is possible when manually separating the boards to impart an undesirable flex to the circuit boards. This flex may cause damage to the electronic components mounted on the circuit board or may damage the electronic connection between such electronic components and the circuit board.

Although the use of a saw or router can reduce the time and labor involved in separating circuit boards and may reduce the risk of damage due to circuit board flex, these devices carry their own disadvantages. The act of cutting through the circuit board can result in the creation of dust consisting of minute particles of the circuit board. This dust can potentially interfere with proper operation of electronic components mounted on the circuit board. In addition, common techniques for sawing through the circuit boards often require a clearance between the electronic circuits and the location of the cutting plane. Punch board methods require similar spacing for tabs between board sections. This can result in a loss of valuable real estate for positioning circuitry on the circuit board. In addition, typically components mounted on the circuit board cannot extend over the cutting plane or punch plane. Extending components, such as terminal pins, past the edge of a circuit board is a well known method of connecting the circuit board to other components. Traditional methods of separating multi-board arrays can interfere with this type of design. Therefore, the use of methods and apparatuses utilizing cutting tools to separate the circuit board can create undesirable limitations on circuit board design.

It would, therefore, be highly desirable to have a method and apparatus for separating circuit boards from a multi-board array that could reduce the time and labor cost commonly associated with manual separation of the circuit boards. Furthermore, it would be highly desirable to have a method and apparatus for separating the circuit boards from a multi-board array to reduce the limitations on circuit board design associated with known methods and apparati for cutting apart the circuit boards.

### SUMMARY OF THE INVENTION

It is, therefore, an object of the present invention to provide a method and apparatus for separating individual circuit boards from a multiple board array with potential reductions in time and labor in separating the circuit boards, with a reduction in potential damage to components installed on each circuit board, and that would reduce the limitations imposed by known methods on circuit board design.

In accordance with the objects of the present invention, a method and apparatus for separating individual circuit boards from a multiple board array is provided. The apparatus for separating individual circuit boards from a multiple board array includes at least one splitting element positioned on the multiple board array along a pre-scored plane. The apparatus further includes at least one torque inducing element mechanically forcing the multiple board array onto the splitting element, thereby breaking the multiple board along the pre-scored plane.

Other objects and features of the present invention will become apparent when viewed in light of the detailed description of the preferred embodiment when taken in conjunction with the attached drawings and the appended claims.

### BRIEF DESCRIPTION OF THE DRAWINGS

FIG. 1 is an illustration of a circuit board for use in the present invention;

FIG. 2 is an illustration of a circuit board for use in the present invention;

FIG. 3 is an illustration of a pre-scored multiple board array for use in the present invention;

FIG. 4 is a top view of the pre-scored multiple board array illustrated in FIG. 3;

FIG. 5 is a side view of an embodiment of an apparatus for separating individual circuit boards from a multiple board array in accordance with the present invention; and

FIG. 6 is an end view of the embodiment of an apparatus for separating individual circuit boards from the multiple board array illustrated in FIG. 5.

### DESCRIPTION OF THE PREFERRED EMBODIMENT(S)

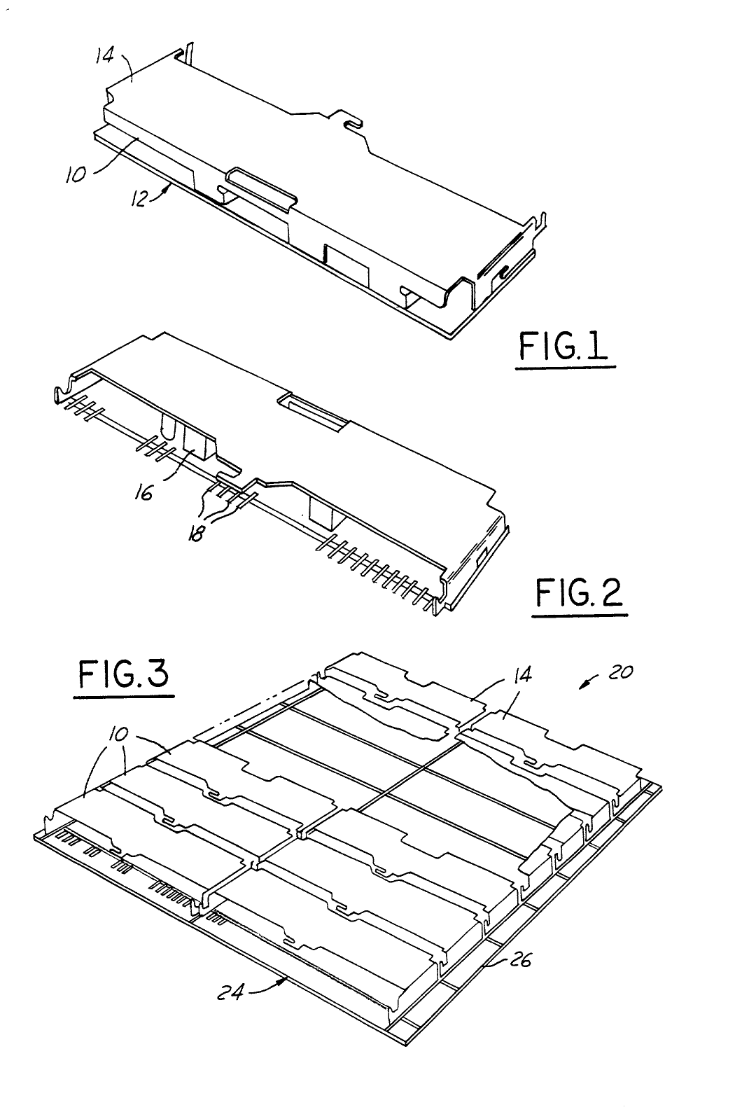

Referring now to FIG. 1, which is an illustration of an individual circuit board 10 for use with the present invention. A wide variety of designs for individual circuit boards 10 are contemplated, and the shown design is intended for illustrative purposes only. The individual circuit board 10 includes a circuit board 12 and a shield element 14. The individual circuit board 10 may further include electronic components 16 and connecting pins 18 (see FIG. 2). Although a variety of components making up the individual circuit board 10 have been shown, it should be understood that a variety of individual circuit board designs are known in the prior art and contemplated by the present invention.

It is known that a wide variety of costs, time, and other manufacturing benefits are achieved by constructing a group of individual circuit boards 10 while formed in a multiple board array 20 (see FIG. 3). The multiple board array 20 includes a plurality of individual circuit boards 10 in addition to border pieces 22. The use of border pieces 22 is not required, however, they provide a valuable unused surface to transport the multiple board array 20 through manufacturing processes. The border pieces 22 can include end pieces 24 and side pieces 26.

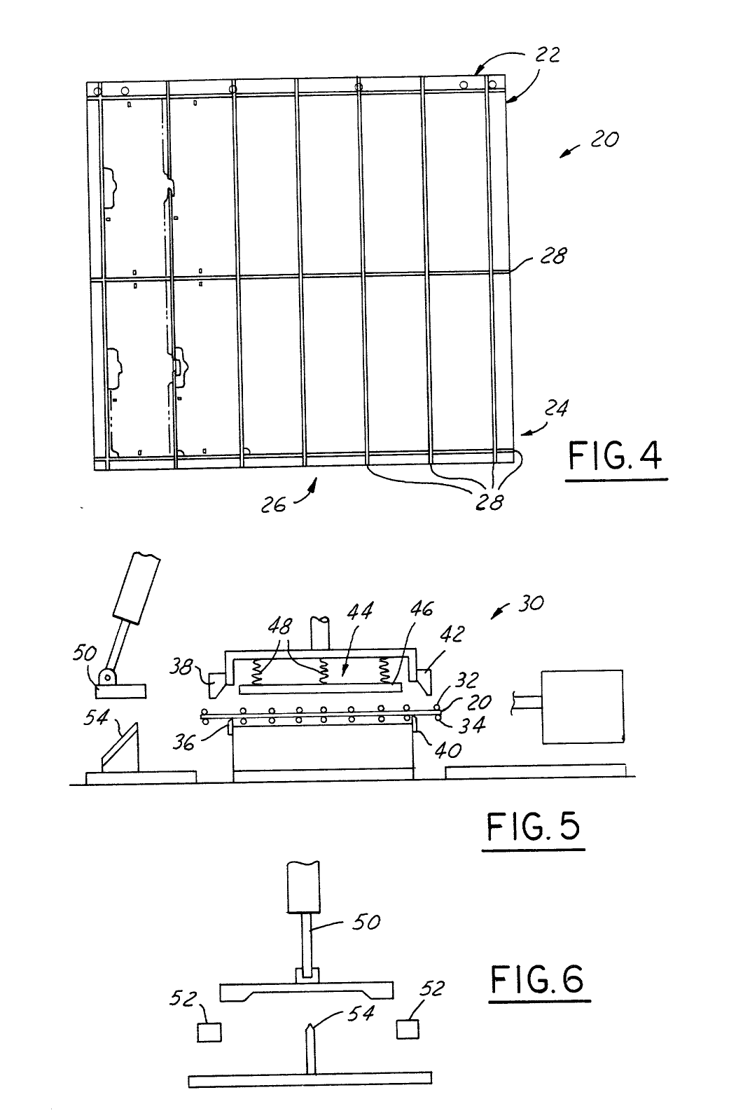

Referring now to FIG. 4 which is a top view of a multi-board array 20 as illustrated in FIG. 3. The multiple board array 20 includes a plurality of pre-scored planes 28. The pre-scored planes 28 are used to define the outer edges of each of the individual circuit boards 10. In one embodiment, the pre-scored planes 28 represent V-scores on the multiple board array 20. In other embodiments, however, the pre-scored planes 28 may simply represent perforations on a perforated circuit board, or tabs on a punch board. All of these methods for pre-scoring the multiple board array 20 are well known in the prior art. Again, the layout and configuration of the multiple board array 20 is for illustrative purposes only and is not intended as a limitation of the present invention.

Referring now to FIG. 5 which is a side view of a method and apparatus for separating the circuit boards from multiple board array 30 in accordance with the present invention. The method and apparatus 30 includes a transport element 32 for moving the multiple board array 20 through the apparatus 30. In one embodiment, the transport element 32 includes a plurality of wheel elements 34 that grip the side pieces 26 of the multiple board array 20. In other embodiments, however, a wide variety of transport elements 32 are contemplated by the present invention. The transport element 32 moves the multiple board array 20 into position such that a first splitting element 36 becomes aligned with one of the pre-scored planes 28 on the multiple board array 20.

A first torque inducing element 38 is used to exert a force on the multiple board array 20 such that the multiple board array 20 breaks and separates along one of the pre-scored planes 28. A wide variety of torque inducing elements are well known in the prior art. In one embodiment the first torque inducing element 38 is a pneumatic lever. The first torque inducing element 38 may be designed in a variety of forms to induce torque on the multiple board array 20 without damaging it. By mechanically applying the torque using a torque inducing element 38 the torque can be applied evenly such that board flex is minimized.

In one embodiment, a second splitting element 40 and a second torque applying element 42 are utilized in combination with the first splitting element 36 and the first torque applying element 38 such that the end pieces 24 of the multiple board array 20 are broken off simultaneously. The apparatus 30 may further include a stabilization element 44 including a pressure board 46 and spring elements 48 that applies low pressure to the multiple board array 20 such that board flex is minimized while the end pieces 24 are broken off.

The transport element 32 then proceeds to move the multiple board array 20 incrementally forward until a new pre-scored plane 28 becomes aligned with a third torque inducing element 50. At this point, the third torque inducing element 50 exerts a force on the multiple board array 20 such that the multiple board array 20 breaks along the pre-scored plane 28. The third torque inducing element 50 continues to act on the multiple board array 20 until the side pieces 26 are broken off by stops 52 and a third splitting element 54 splits the multiple circuit board 20 along the final pre-scored plane 28. The individual circuit board 10 has thereby been quickly and effectively separated from the multiple board array 20. By continuing to incrementally move the multiple board array 20 through the apparatus 30, the multiple board array 20 is eventually broken down into a plurality of individual circuit board 10.

It should be understood that the layout and design of the apparatus for separating circuit boards from a multiple board array 30 may be altered and modified to handle a wide variety of designs and configurations of multiple board arrays 20. The principal of using a first splitting device 36 and a first torque delivery device 38 allows the boards (in any configuration) to be separated quickly and easily. In addition, this system, when used with a plurality of splitting elements 36, 52, 54, and a plurality of torque inducing elements 38, 50, may be used to automatically separate individual circuit boards 10 from even complex multiple board arrays 20. In one embodiment, the form of the splitting elements 36, 54 may take the form of a simple ledge. In other embodiments, the splitting elements 52 may take the form of a simple supporting block. Although two embodiments have been described, a wide variety of splitting elements are contemplated. Similarly, the torque inducing elements 38, 50 may take a variety of forms including edge loading 38 or surface loading forms 50. Although not necessary to practice the invention, the use of shielding 14 can allow for a broader range of designs and simpler construction of the torque inducing elements 38, 50. Finally, although the splitting planes have been described as pre-scored planes 28, it should be understood that this is meant to encompass perforated planes and even punch board tab planes.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An apparatus for separating individual circuit boards from a multiple board array with pre-scored planes comprising:
at least one splitting element positioned along one of the pre-scored planes; and
at least one torque inducing element mechanically forcing the multiple board array onto said at least one splitting element and thereby breaking the multiple board array along the pre-scored plane.

2. An apparatus as described in claim 1 further comprising:
a stabilizing element exerting a load on the surface of the multiple board array and thereby reducing board flex.

3. An apparatus as described in claim 1 wherein said stabilizing element includes a plate element; and
a plurality of spring elements, said plurality of spring elements pushing said plate element onto the multiple board array.

4. An apparatus as described in claim 1 wherein said at least one splitting element is wedge shaped.

5. An apparatus as described in claim 1 wherein said at least one splitting element is block shaped.

6. An apparatus as described in claim 1 further comprising:
a transport element for automatically positioning said at least one splitting element along one of the pre-scored planes.

7. An apparatus as described in claim 1 wherein said transport element includes a plurality of wheels.

8. An apparatus as described in claim 1 wherein said at least one torque moving element is a pneumatic lever.

9. An apparatus for separating individual circuit board from a multiple board array with pre-scored planes comprising:
at least one splitting element positioned along one of the pre-scored planes; and
at least one torque inducing element mechanically forcing the multiple board array onto said at least one splitting element and thereby breaking the multiple board array along the pre-scored plane; and
a transport element for automatically positioning said at least one splitting element along one of the pre-scored planes.

10. An apparatus as described in claim 9 further comprising:
a stabilizing element exerting a load on the surface of the multiple board array and thereby reducing board flex.

11. An apparatus as described in claim 9 wherein said stabilizing element includes a plate element; and
a plurality of spring elements, said plurality of spring elements pushing said plate element onto the multiple board array.

12. An apparatus as described in claim 9 wherein said at least one splitting element is wedge shaped.

13. An apparatus as described in claim 9 wherein said at least one splitting element is block shaped.

14. An apparatus as described in claim 9 wherein said transport element includes a plurality of wheels.

15. An apparatus as described in claim 9 wherein said at least one torque moving element is a pneumatic lever.

16. A method for separating individual circuit boards from a multiple board array with pre-scored planes comprising:
positioning a splitting element along one of the pre-scored planes inducing torque on the multiple board array such that the multiple board array is forced onto the splitting element and breaks along the pre-scored plane.

17. A method for separating individual circuit boards as described in claim 16 further comprising:
loading the surface of the multiple board array to reduce board flex.

18. A method of separating individual circuit boards from a multiple board array as described in claim 16 further comprising:
transporting the multiple board array using a plurality of wheels.

19. A method of separating individual circuit boards from a multiple board array with pre-scored planes as described in claim 16 further comprising:
repeating said positioning and said inducing torque on each pre-scored plane.
